(19) United States
(12) Patent Application Publication
(10) Pub. No.: US 2025/0203408 A1
(43) Pub. Date: Jun. 19, 2025

(54) COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Boyuan ZHANG, Dongguan (CN); Qianxi LU, Dongguan (CN); Bingxue LENG, Dongguan (CN)

(21) Appl. No.: 19/072,594

(22) Filed: Mar. 6, 2025

Related U.S. Application Data
(63) Continuation of application No. PCT/CN2022/121065, filed on Sep. 23, 2022.

(51) Int. Cl. H04W 24/02; H04W 28/02; H04W 92/18

(52) U.S. Cl. CPC H04W 24/02; H04W 28/0268; H04W 28/0273; H04W 92/18

(57) ABSTRACT

Provided is a communication method. The method is applicable to a first device in an end-to-end relay service, and includes: transmitting a first configuration parameter related to the end-to-end relay service to a second device in the end-to-end relay service, wherein a first remote terminal device, a relay terminal device, and a second remote terminal device participate in the end-to-end relay service, and the first configuration parameter includes at least one of: an end-to-end configuration parameter, a first per-hop configuration parameter, or a second per-hop configuration parameter.

### CROSS-REFERENCE TO RELATED APPLICATION

This application is a continuation of International Application No. PCT/CN2022/121065, filed Sep. 23, 2022, the entire disclosure of which is incorporated herein by reference.

### TECHNICAL FIELD

Embodiments of the present disclosure relate to the field of communication technologies, and in particular, relate to a communication method, a communication apparatus, a device, a storage medium, and a program product.

### BACKGROUND

User equipment (UE)-to-UE (U2U) communications are a sidelink communication technology. That is, near field communications for direct information connection are achieved between UEs over a proximity services communication 5 (PC5) interface.

### SUMMARY

Embodiments of the present disclosure provide a communication method and a terminal device. The technical solutions are as follows.

According to an aspect of some embodiments of the present disclosure, a communication method is provided. The method is applicable to a first device in an end-to-end relay service. The method includes:
transmitting a first configuration parameter related to the end-to-end relay service to a second device in the end-to-end relay service, wherein a first remote terminal device, a relay terminal device, and a second remote terminal device participate in the end-to-end relay service, and the first configuration parameter includes at least one of: an end-to-end configuration parameter, wherein the end-to-end configuration parameter includes a configuration parameter for service transmission between the first remote terminal device and the second remote terminal device; a first per-hop configuration parameter, wherein the first per-hop configuration parameter includes a configuration parameter for service transmission between the first remote terminal device and the relay terminal device; or a second per-hop configuration parameter, wherein the second per-hop configuration parameter includes a configuration parameter for service transmission between the second remote terminal device and the relay terminal device.

According to some embodiments of the present disclosure, a terminal device is provided. The terminal device includes: a processor and a memory storing one or more computer programs, wherein the processor, when loading and running the one or more computer programs, is caused to perform the communication method applicable to the first device and the communication method applicable to the second device.

### BRIEF DESCRIPTION OF THE DRAWINGS

FIG. 1 is a schematic diagram of a network architecture according to some embodiments of the present disclosure;

FIG. 2 is a schematic diagram of a network architecture in an end-to-end relay scenario according to some embodiments of the present disclosure;

FIG. 3 is a flowchart of a communication method according to some embodiments of the present disclosure;

FIG. 4 is a flowchart of a communication method according to some embodiments of the present disclosure;

FIG. 5 is a flowchart of configuration of an end-to-end quality of service (QoS) parameter according to some embodiments of the present disclosure;

FIG. 6 is a block diagram of a communication apparatus according to some embodiments of the present disclosure;

FIG. 7 is a block diagram of a communication apparatus according to some embodiments of the present disclosure; and

FIG. 8 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios in the embodiments of the present disclosure are intended to describe the technical solutions according to the embodiments of the present disclosure more clearly, but do not constitute a limitation on the technical solutions according to the embodiments of the present disclosure. Those of ordinary skill in the art acknowledge that, with the evolution of the network architecture and the emergence of new service scenarios, the technical solutions according to the embodiments of the present disclosure are also applicable to similar technical problems.

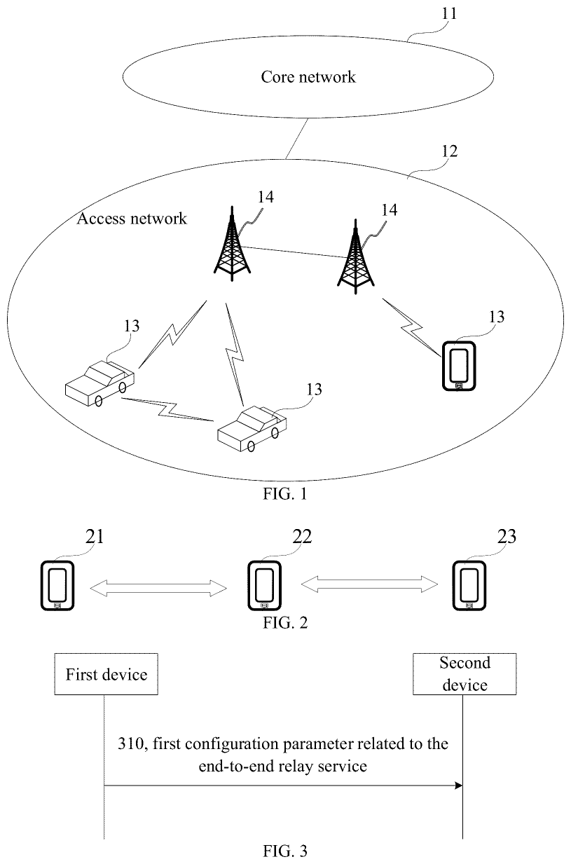

FIG. 1 is a block diagram of a network architecture according to some embodiments of the present disclosure. The network architecture involves a core network 11, an access network 12, and a terminal device 13.

The core network 11 includes several core network devices. Each of the core network devices mainly functions to provide user connection, user management and service bearing, and acts as a bearer network for providing an interface to an external network. For example, the core network of a 5G new radio (NR) system includes an access and mobility management function (AMF) entity, a user plane function (UPF) entity, a session management function (SMF) entity, and other devices.

The access network 12 includes several access network devices 14. The access network in a 5G NR system is also referred to as a new generation-radio access network (NG-RAN). The access network device 14 is a device deployed in the access network 12 and configured to provide a wireless communication function to the terminal device 13. The access network device 14 includes various types of macro base stations, micro base stations, relay stations, access points, and the like. In systems using different radio access technologies, names of the devices with the access network device function are different, for example, referred to as the gNodeBs, or gNBs in 5G NR systems. With the evolution of communications technologies, the name “access network device” may change. For convenient description, the above devices providing the wireless communication function for the terminal device 13 are collectively referred to as the access network device in the embodiments of the present disclosure.

Generally, a plurality of terminal devices 13 are provided. One or more terminal devices 13 are disposed in a cell managed by each of the access network devices 14. The terminal device 13 includes various handheld devices, vehicle-mounted devices, wearable devices, computing devices or other processing devices connected to wireless modems, various forms of user devices, mobile stations (MS), and other devices with the wireless communication function. For convenient description, the above devices are collectively referred to as the terminal device. The access network device 14 and the core network device communicate with each other using the air interface technology, such as the NG interface in the 5G NR system. The access network device 14 and the terminal device 13 communicate with each other using the air interface technology, such as a Uu interface.

The terminal devices 13, for example, the in-vehicle device and other devices (such as other in-vehicle devices, mobile phones, road side units (RSU), or the like), communicate with each other over a direct communication interface (for example, a PC5 interface), and the communication link over the direct communication interface is accordingly referred to as a direct link or sidelink. The sidelink communication indicates that the direct communication data transmission between the terminals is achieved over the SL, and is different from the traditional cellular system in which the communication data is received or transmitted over the access network device. Thus, the sidelink communication has the characteristics of short delay and low overhead, and is suitable for the communication between two terminal devices at near geographical locations (such as an in-vehicle device and other peripheral devices at near geographical locations). It should be noted that FIG. 1 is illustrated using an example of the vehicle-to-vehicle communication in the vehicle-to-everything (V2X) scenario, and the sidelink technology is applicable to the scenario where various terminal devices directly communicate with each other. In other words, the terminal device in the present disclosure refers to any type of equipment that achieves communication using the sidelink technology.

The “5G NR system” in the embodiments of the present disclosure is also referred to as a 5G system or an NR system, and those skilled in the art understand the meaning. The technical solutions according to the embodiments of the present disclosure are applicable to the 5G NR system and evolved systems of the 5G NR system.

In U2U relay, data is relayed by a relay terminal device (or referred to as a relay UE) to a source remote terminal device (or referred to as a source UE) and a target remote terminal device (or referred to as a remote UE), such that the source remote terminal device communicates with the target remote terminal device. However, further researches are required for a U2U relay transmission mode.

Referring to FIG. 2, FIG. 2 is a schematic diagram of a network architecture in a U2U relay transmission scenario (that is, an end-to-end relay a service) according to some embodiments of the present disclosure. The U2U relay transmission scenario involves a first remote terminal device 21, a relay terminal device 22, and a second remote terminal device 23. The end-to-end service transmission is achieved between the first remote terminal device 21 and the second remote terminal device 23 by the relay terminal device 22. The first remote terminal device 21 directly communicates with the relay terminal device 22 over a sidelink established based on a direct connection interface (for example, a PC5 interface), and the second remote terminal device 21 directly communicates with the relay terminal device 22 over a sidelink established based on a direct connection interface (for example, a PC5 interface).

The U2U relay transmission scenario involves the following terms.

1. A source remote terminal device refers to a terminal device in the first remote terminal device and the second remote terminal device that transmits a direct communication request message.

2. A target remote terminal device refers to a terminal device in the first remote terminal device and the second remote terminal device that receives a direct communication request message.

3. A transmitter terminal device refers to a terminal device in the first remote terminal device and the second remote terminal device that transmits service data.

4. A receiver terminal device refers to a terminal device in the first remote terminal device and the second remote terminal device that receives service data.

Illustratively, assuming that in the U2U relay transmission scenario shown in FIG. 2, the first remote terminal device 21 transmits the direct communication request message to the second remote terminal device 23, and the direct communication request message requests to establish an end-to-end direct connection link; and accordingly, the second remote terminal device 23 receives the direct communication request message from the first remote terminal device 21, then the first remote terminal device 21 is the source remote terminal device, and the second remote terminal device 23 is the target remote terminal device.

Illustratively, assuming that in the U2U relay transmission scenario shown in FIG. 2, the second remote terminal device 23 transmits the direct communication request message to the first remote terminal device 21, and the direct communication request message requests to establish an end-to-end direct connection link; and accordingly, the first remote terminal device 21 receives the direct communication request message from the second remote terminal device 23, then the first remote terminal device 21 is the target remote terminal device, and the second remote terminal device 23 is the source remote terminal device.

Illustratively, assuming that in the U2U relay transmission scenario shown in FIG. 2, the first remote terminal device 21 transmits the service data to the second remote terminal device 23, and accordingly, the second remote terminal device 23 receives the service data from the first remote terminal device 21, then the first remote terminal device 21 is the transmitter terminal device, and the second remote terminal device 23 is the receiver terminal device.

Illustratively, assuming that in the U2U relay transmission scenario shown in FIG. 2, the second remote terminal device 23 transmits the service data to the first remote terminal device 21, and accordingly, the first remote terminal device 21 receives the service data from the second remote terminal device 23, then the first remote terminal device 21 is the receiver terminal device, and the second remote terminal device 23 is the transmitter terminal device.

In addition, the source remote terminal device acts as the transmitter terminal device or the receiver terminal device. Similarly, the target remote terminal device acts as the transmitter terminal device or the receiver terminal device. For any remote terminal device in the first remote terminal device and the second remote terminal device, the remote terminal device may freely switch between acting as the transmitter terminal device and acting as the receiver terminal device, or the remote terminal device acts as the transmitter terminal device and the receiver terminal device simultaneously.

FIG. 3 is a flowchart of a communication method according to some embodiments of the present disclosure. The method is applicable to the network architecture shown in FIG. 1 and FIG. 2. The method includes S310.

In S310, a first device in an end-to-end relay service transmits a first configuration parameter related to the end-to-end relay service to a second device in the end-to-end relay service.

Accordingly, the second device in the end-to-end relay service receives the first configuration parameter related to the end-to-end relay service from the first device in the end-to-end relay service.

That is, the first device transmits the first configuration parameter related to the first service to the second device. The first service is the end-to-end relay service in the first remote terminal device, the relay remote terminal device, and the second remote terminal device. Accordingly, the second device receives the first configuration parameter related to the first service from the first device.

The first remote terminal device, the relay terminal device, and the second remote terminal device participate in the end-to-end relay service. In some embodiments, the first device is one of the first remote terminal device, the relay terminal device, and the second remote terminal device. In some embodiments, the second device is a terminal device different from the first device in the first remote terminal device, the relay terminal device, and the second remote terminal device.

Illustratively, the first device is the first remote terminal device, and the second device is the relay terminal device and/or the second remote terminal device.

Illustratively, the first device is the relay terminal device, and the second device is the first remote terminal device and/or the second remote terminal device.

Illustratively, the first device is the second remote terminal device, and the second device is the relay terminal device and/or the first remote terminal device.

In some embodiments, the first configuration parameter refers to a configuration parameter related to the end-to-end relay service, for example, a QoS parameter or other parameter, which are detailed in the following embodiments. The first configuration parameter is configured by a terminal device participating in the end-to-end relay service or a network device of the terminal device, and is transmitted from the terminal device to other terminal devices participating in the end-to-end relay service, such that the first configuration parameter is synchronously negotiated in a plurality of terminal devices participating in the end-to-end relay service.

In some embodiments, the first configuration parameter includes at least one of: an end-to-end configuration parameter, a first per-hop configuration parameter, or a second per-hop configuration parameter. The end-to-end configuration parameter includes a configuration parameter for service transmission between the first remote terminal device and the second remote terminal device. The first per-hop configuration parameter includes a configuration parameter for service transmission between the first remote terminal device and the relay terminal device. The second per-hop configuration parameter includes a configuration parameter for service transmission between the second remote terminal device and the relay terminal device.

In some embodiments, the end-to-end configuration parameter includes at least one of a first parameter or a second parameter. The first parameter includes a configuration parameter for service transmission from the first remote terminal device to the second remote terminal device, and the second parameter includes a configuration parameter for service transmission from the second remote terminal device to the first remote terminal device.

In some embodiments, the first per-hop configuration parameter includes at least one of a third parameter or a fourth parameter. The third parameter includes a configuration parameter for service transmission from the first remote terminal device to the relay terminal device, and the fourth parameter includes a configuration parameter for service transmission from the relay terminal device to the first remote terminal device.

In some embodiments, the second per-hop configuration parameter includes at least one of a fifth parameter or a sixth parameter. The fifth parameter includes a configuration parameter for service transmission from the second remote terminal device to the relay terminal device, and the sixth parameter includes a configuration parameter for service transmission from the relay terminal device to the second remote terminal device.

In some embodiments, the first configuration parameter is any combination of the above parameters.

Illustratively, the first configuration parameter includes the first parameter and/or the second parameter. In this case, the first configuration parameter is used for configuring a parameter related to the end-to-end service transmission.

Illustratively, the first configuration parameter includes at least one of the first parameter, the third parameter, or the sixth parameter. In this case, the first configuration parameter is used for configuring the end-to-end configuration parameter and/or the per-hop configuration parameter for service transmission from the first remote terminal device to the second remote terminal device.

Illustratively, the first configuration parameter includes at least one of the second parameter, the fourth parameter, or the fifth parameter. In this case, the first configuration parameter is used for configuring the end-to-end configuration parameter and/or the per-hop configuration parameter for service transmission from the second remote terminal device to the first remote terminal device.

Illustratively, the first configuration parameter includes the third parameter and/or the fourth parameter. In this case, the first configuration parameter is used for configuring the per-hop configuration parameter between the first remote terminal device and the relay terminal device.

Illustratively, the first configuration parameter includes the fifth parameter and/or the sixth parameter. In this case, the first configuration parameter is used for configuring the per-hop configuration parameter between the second remote terminal device and the relay terminal device.

Illustratively, the first configuration parameter includes the fourth parameter and/or the sixth parameter. In this case, the first configuration parameter is used for configuring the parameter for service transmission from the relay terminal device to the remote terminal device.

Illustratively, the first configuration parameter includes the third parameter and/or the fifth parameter. In this case, the first configuration parameter is used for configuring the parameter for service transmission from the remote terminal device to the relay terminal device.

In addition, the first device and the second device may be the following combinations.

In some embodiments, the first device acts as a remote terminal device of a service transmitter, and the second device acts as a remote terminal device and/or a relay terminal device of a service receiver.

Illustratively, the first device acts as the remote terminal device of the service transmitter, and the second device acts as the remote terminal device of the service receiver. In this case, the first configuration parameter transmitted from the first device to the second device includes the end-to-end configuration parameter, or includes the first per-hop configuration parameter and/or the second per-hop configuration parameter, or includes the end-to-end configuration parameter, the first per-hop configuration parameter, and the second per-hop configuration parameter.

Illustratively, assuming that the first device is the first remote terminal device and acts as the service transmitter, and the second device is the second remote terminal device and acts as the service receiver, then the first configuration parameter transmitted from the first device to the second device includes the first parameter, or includes the third parameter and/or the sixth parameter, or includes the first parameter, the third parameter, and the sixth parameter.

Illustratively, assuming that the first device is the second remote terminal device and acts as the service transmitter, and the second device is the first remote terminal device and acts as the service receiver, then the first configuration parameter transmitted from the first device to the second device includes the second parameter, or includes the fourth parameter and/or the fifth parameter, or includes the second parameter, the fourth parameter, and the fifth parameter.

Illustratively, the first device acts as the remote terminal device of the service transmitter, and the second device acts as the relay terminal device of the service receiver. In this case, the first configuration parameter transmitted from the first device to the second device includes the first per-hop configuration parameter and/or the second per-hop configuration parameter and alternatively includes the end-to-end configuration parameter.

Illustratively, assuming that the first device is the first remote terminal device and acts as the service transmitter, and the second device is the relay terminal device and acts as the service receiver, then the first configuration parameter transmitted from the first device to the second device includes the third parameter, or includes the third parameter and the first parameter.

Illustratively, assuming that the first device is the second remote terminal device and acts as the service transmitter, and the second device is the relay terminal device and acts as the service receiver, then the first configuration parameter transmitted from the first device to the second device includes the fifth parameter, or includes the fifth parameter and the first parameter.

Illustratively, the first device acts as the remote terminal device of the service transmitter, and the second device acts as the remote terminal device and the relay terminal device of the service receiver. In this case, the first configuration parameter transmitted from the first device to the second device includes the end-to-end configuration parameter, or includes the first per-hop configuration parameter and/or the second per-hop configuration parameter, or includes the end-to-end configuration parameter, the first per-hop configuration parameter, and the second per-hop configuration parameter.

Illustratively, assuming that the first device is the first remote terminal device and acts as the service transmitter, and the second device is the relay terminal device and the second remote terminal device and acts as the service receiver, then the first configuration parameter transmitted from the first device to the second device includes the first parameter, or includes the third parameter and/or the sixth parameter, or includes the first parameter, the third parameter, and the sixth parameter.

Illustratively, assuming that the first device is the second remote terminal device and acts as the service transmitter, and the second device is the relay terminal device and the first remote terminal device and acts as the service receiver, then the first configuration parameter transmitted from the first device to the second device includes the second parameter, or includes the fourth parameter and/or the fifth parameter, or includes the second parameter, the fourth parameter, and the fifth parameter.

In some embodiments, the first device acts as the remote terminal device of the service receiver, and the second device acts as the remote terminal device and the relay terminal device of the service transmitter.

Illustratively, the first device acts as the remote terminal device of the service receiver, and the second device acts as the remote terminal device of the service transmitter. In this case, the first configuration parameter transmitted from the first device to the second device includes the end-to-end configuration parameter, or includes the first per-hop configuration parameter and/or the second per-hop configuration parameter, or includes the end-to-end configuration parameter, the first per-hop configuration parameter, and the second per-hop configuration parameter.

Illustratively, assuming that the first device is the first remote terminal device and acts as the service receiver, and the second device is the second remote terminal device and acts as the service transmitter, then the first configuration parameter transmitted from the first device to the second device includes the second parameter, or includes the fourth parameter and/or the fifth parameter, or includes the second parameter, the fourth parameter, and the fifth parameter.

Illustratively, assuming that the first device is the second remote terminal device and acts as the service receiver, and the second device is the first remote terminal device and acts as the service transmitter, then the first configuration parameter transmitted from the first device to the second device includes the first parameter, or includes the third parameter and/or the sixth parameter, or includes the first parameter, the third parameter, and the sixth parameter.

Illustratively, the first device acts as the remote terminal device of the service receiver, and the second device acts as the relay terminal device of the service transmitter. In this case, the first configuration parameter transmitted from the first device to the second device includes the first per-hop configuration parameter and/or the second per-hop configuration parameter, and alternatively includes the end-to-end configuration parameter.

Illustratively, assuming that the first device is the first remote terminal device and acts as the service receiver, and the second device is the relay terminal device and acts as the service transmitter, then the first configuration parameter transmitted from the first device to the second device includes the fourth parameter, or includes the fourth parameter and the second parameter.

Illustratively, assuming that the first device is the second remote terminal device and acts as the service receiver, and the second device is the relay terminal device and acts as the service transmitter, then the first configuration parameter transmitted from the first device to the second device includes the sixth parameter, or includes the sixth parameter and the first parameter.

Illustratively, the first device acts as the remote terminal device of the service receiver, and the second device acts as the remote terminal device and the relay terminal device of the service transmitter. In this case, the first configuration parameter transmitted from the first device to the second device includes the end-to-end configuration parameter, or includes the first per-hop configuration parameter and/or the second per-hop configuration parameter, or includes the end-to-end configuration parameter, the first per-hop configuration parameter, and the second per-hop configuration parameter.

Illustratively, assuming that the first device is the first remote terminal device and acts as the service receiver, and the second device is the relay terminal device and the second remote terminal device and acts as the service transmitter, then the first configuration parameter transmitted from the first device to the second device includes any one of the second parameter, the fourth parameter, or the fifth parameter.

Illustratively, assuming that the first device is the second remote terminal device and acts as the service receiver, and the second device is the relay terminal device and the first remote terminal device and acts as the service transmitter, then the first configuration parameter transmitted from the first device to the second device includes any one of the first parameter, the third parameter, or the sixth parameter.

In some embodiments, the first device acts as the relay terminal device of the service transmitter, and the second device acts as the remote terminal device of the service receiver.

Illustratively, the first device acts as the relay terminal device of the service transmitter, and the second device acts as the first remote terminal device and/or the second remote terminal device of the service receiver. In this case, the first configuration parameter transmitted from the first device to the second device includes the end-to-end configuration parameter, or includes the first per-hop configuration parameter and/or the second per-hop configuration parameter, or includes the end-to-end configuration parameter, the first per-hop configuration parameter, and the second per-hop configuration parameter.

Illustratively, assuming that the first device is the relay terminal device and acts as the service transmitter, and the second device is the first remote terminal device and acts as the service receiver, then the first configuration parameter transmitted from the first device to the second device includes the fourth parameter, or includes the second parameter, or includes the fourth parameter and the second parameter, or includes the fourth parameter and the third parameter.

Illustratively, assuming that the first device is the relay terminal device and acts as the service transmitter, and the second device is the second remote terminal device and acts as the service receiver, then the first configuration parameter transmitted from the first device to the second device includes the sixth parameter, or includes the first parameter, or includes the sixth parameter and the first parameter, or includes the sixth parameter and the fifth parameter.

Illustratively, assuming that the first device is the relay terminal device and acts as the service transmitter, and the second device is the first remote terminal device and the second remote terminal device and acts as the service receiver, then the first configuration parameter transmitted from the first device to the second device includes the fourth parameter and/or the sixth parameter.

In some embodiments, the first device acts as the relay terminal device of the service receiver, and the second device acts as the remote terminal device of the service transmitter.

Illustratively, the first device acts as the relay terminal device of the service receiver, and the second device acts as the first remote terminal device and/or the second remote terminal device of the service transmitter. In this case, the first configuration parameter transmitted from the first device to the second device includes the end-to-end configuration parameter, or includes the first per-hop configuration parameter and/or the second per-hop configuration parameter, or includes the end-to-end configuration parameter, the first per-hop configuration parameter, and the second per-hop configuration parameter.

Illustratively, assuming that the first device is the relay terminal device and acts as the service receiver, and the second device is the first remote terminal device and acts as the service transmitter, then the first configuration parameter transmitted from the first device to the second device includes the third parameter, or includes the first parameter, or includes the third parameter and the first parameter, or includes the third parameter and the fourth parameter.

Illustratively, assuming that the first device is the relay terminal device and acts as the service receiver, and the second device is the second remote terminal device and acts as the service transmitter, then the first configuration parameter transmitted from the first device to the second device includes the fifth parameter, or includes the second parameter, or includes the fifth parameter and the second parameter, or includes the fifth parameter and the sixth parameter.

Illustratively, assuming that the first device is the relay terminal device and acts as the service receiver, and the second device is the first remote terminal device and the second remote terminal device and acts as the service transmitter, then the first configuration parameter transmitted from the first device to the second device includes the third parameter and/or the fifth parameter.

In some embodiments, the first configuration parameter includes at least one of an end-to-end QoS parameter, an end-to-end Sidelink Relay Adaptation Protocol (SRAP) configuration parameter, an end-to-end Packet Data Convergence Protocol (PDCP) configuration parameter, an end-to-end Service Data Adaptation Protocol (SDAP) configuration parameter, a per-hop QoS parameter, or a per-hop radio link control (RLC) configuration parameter.

In conjunction with the above description, the end-to-end configuration parameter includes at least one of the end-to-end QoS parameter, the end-to-end SRAP configuration parameter, the end-to-end PDCP configuration parameter, or the end-to-end SDAP configuration parameter. The first per-hop configuration parameter and/or the second per-hop configuration parameter includes at least one of the per-hop QoS parameter or the per-hop RLC configuration parameter. For detailed description of various types of parameters and the terminal devices for configuring the parameters, reference may be made to the description in the following embodiments.

In some embodiments, the first configuration parameter is determined by the first device. That is, the first device configures the first configuration parameter.

In some embodiments, the first configuration parameter is determined by a network device of the first device. That is, the network device of the first device configures the first configuration parameter. For example, the first configuration parameter is determined by an access network device (example, a station) of the first device. The network device of the first device transmits the first configuration parameter to the first device, and the first device transmits the first configuration parameter to the second device. For example, the network device of the first device transmits the first configuration parameter to the first device over a radio resource control (RRC) message or a system broadcast message.

In some embodiments, in the case that the first device is in an RRC connected state, the first configuration parameter is determined by the network device of the first device or by the first device.

In some embodiments, in the case that the first device is in a non-connected state, for example, in the case that the first device is in an RRC idle state or an RRC non-activated state, the first configuration parameter is determined by the first device.

In some embodiments, the remote terminal device (including the first remote terminal device and/or the second remote terminal device) communicates with the relay terminal device over the sidelink established based on the direct connection interface. Information required to be transmitted between the first remote terminal device and the second remote terminal device is relayed and forwarded by the relay terminal device.

In some embodiments, the first device transmits a first message to the second device, and the first message includes the first configuration parameter related to the end-to-end relay service. Illustratively, the first message is a PC5-8 message, or a PC5-RRC message. The PC5-8 message includes, but is not limited to at least one of a direct communication request message, a direct communication accept message, a link identifier update request message, a link identifier update response/acknowledgement message, a disconnect request message, a disconnect response message, a link modification request message, a link modification accept message, a keep alive message, a keep alive acknowledgement message.

In some embodiments, the first device or the network device of the first device determines the first configuration parameter based on capability information of the first device. The capability information of the first device indicates a capability of the first device, which including, but not limited to a supported maximum bandwidth, and other capabilities.

In some embodiments, in response to receiving the first configuration parameter from the first device, the second device determines whether to accept the first configuration parameter.

In some embodiments, in response to receiving the first configuration parameter from the first device, the second device transmits a request message to a network device of the second device, wherein the request message requests to determine whether to accept the first configuration parameter; and the second device receives a response message from the network device of the second device, wherein the response message indicates acceptance or rejection of the first configuration parameter.

In some embodiments, in the case that the second device is in an RRC connected state, whether to accept the first configuration parameter from the first device is determined by the network device of the second device or by the second device.

In some embodiments, in the case that the second device is in a non-connected state, for example, in the case that the second device is in an RRC idle state or an RRC non-activated state, whether to accept the first configuration parameter from the first device is determined by the second device.

In some embodiments, in response to acceptance of the first configuration parameter, the second device transmits a first feedback message to the first device, and the first feedback message instructs the second device to accept the first configuration parameter. Accordingly, the first device receives the first feedback message from the second device.

In some embodiments, in response to rejection (that is, non-acceptance) of the first configuration parameter, the second device transmits a second feedback message to the first device, and the second feedback message instructs the second device to reject the first configuration parameter. Accordingly, the first device receives the second feedback message from the second device.

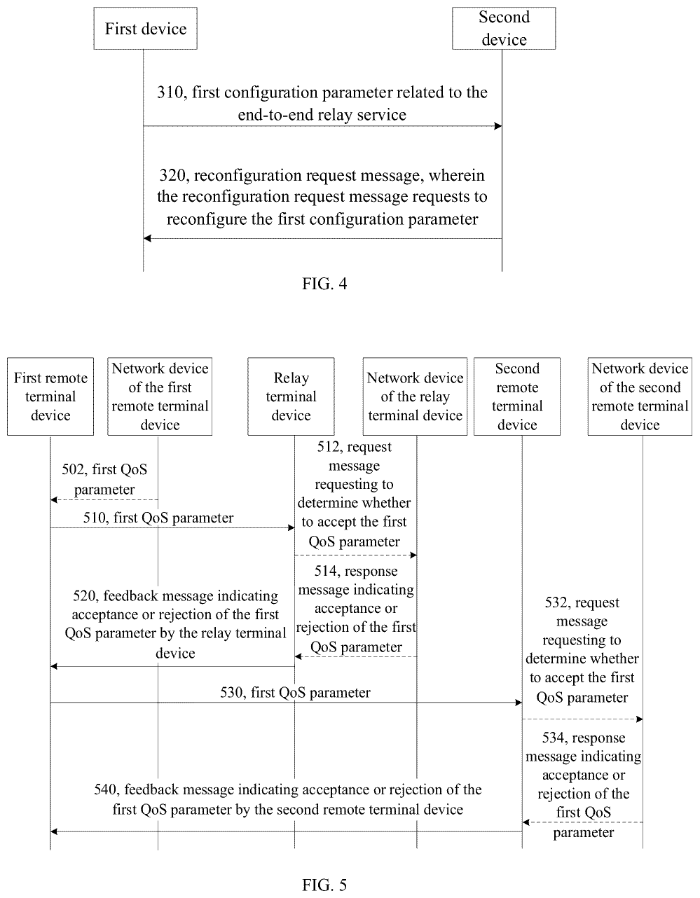

In some embodiments, as shown in FIG. 4, upon S310, the method further includes S320. That is, the second device transmits a reconfiguration request message to the first device in response to rejection of the first configuration parameter, and the reconfiguration request message requests to reconfigure the first configuration parameter. Accordingly, the first device receives the reconfiguration request message from the second device in response to rejection of the first configuration parameter.

In some embodiments, the reconfiguration request message includes a second configuration parameter related to the end-to-end relay service. The second configuration parameter is a parameter with a same configuration item as the first configuration parameter and a different parameter value. For example, the first configuration parameter includes the QoS parameter, wherein a parameter value of the QoS parameter in the first configuration parameter is A; and the second configuration parameter includes the QoS parameter, wherein a parameter value of the QoS parameter in the second configuration parameter is B, B being different from A. That is, in the case that the second device or the network device of the second device determines to reject the first configuration parameter, the second device or the network device of the second device may feed back the second configuration parameter to the first device in some embodiments, and the second configuration parameter is a configuration parameter acceptable by the second device, such that the first device clearly knows, based on the second configuration parameter, the configuration parameter expected or supported by the second device and thus reconfigures the first configuration parameter. Thus, the accuracy of parameter configuration is improved, the negotiation process between devices is simplified, and the efficiency of parameter configuration is improved.

In some embodiments, at least one of the first feedback message, the second feedback message, or the reconfiguration request message is a PC5-8 message, or a PC5-RRC message, which is not limited in the present disclosure.

In some embodiments, the network device of the second device transmits a response message indicating acceptance or rejection of the first configuration parameter and/or transmits the second configuration parameter to the second device over an RRC message, a medium access control (MAC) control element (CE) message, or downlink control information (DCI). In addition, the second configuration parameter and the response message indicating acceptance or rejection of the first configuration parameter may be transmitted over a same message or transmitted separately over two messages, which is not limited in the present disclosure.

In some embodiments, the second configuration parameter is determined by the second device. That is, the second device configures the second configuration parameter.

In some embodiments, the second configuration parameter is determined by the network device of the second device. That is, the network device of the second device configures the second configuration parameter. For example, the second configuration parameter is determined by an access network device (example, a station) of the second device. The network device of the second device transmits the second configuration parameter to the second device, and the second device transmits the second configuration parameter to the first device. For example, the network device of the second device transmits the second configuration parameter to the second device over an RRC message.

In some embodiments, in the case that the second device is in an RRC connected state, the second configuration parameter is determined by the network device of the second device or by the second device.

In some embodiments, in the case that the second device is in a non-connected state, for example, in the case that the second device is in an RRC idle state or an RRC non-activated state, the second configuration parameter is determined by the second device.

In some embodiments, in response to receiving the reconfiguration request message, the first device transmits reconfigured first configuration parameter to the second device. In some embodiments, in the case that the first device receives the second configuration parameter, the first device determines the reconfigured first configuration parameter based on the second configuration parameter. For example, the first device directly determines the second configuration parameter as the reconfigured first configuration parameter, or the first device determines the reconfigured first configuration parameter based on the second configuration parameter and capability information of the first device.

In some embodiments, the first device determines, based on a first timer, whether the configuration parameter related to the end-to-end relay service is successfully configured. The first device may maintain the first timer to determine, based on the first timer, whether the configuration parameter related to the end-to-end relay service is successfully configured. For example, when or after the first device transmits the first configuration parameter to the second device, the first device starts the first timer. In the case that the first device receives the first feedback message from the second device or does not receive the second feedback message from the second device prior to expiration of the first timer, the first device determines that the configuration parameter related to the end-to-end relay service is successfully configured. Otherwise, in the case that the first device does not receive the first feedback message in expiration of the first timer or receives the second feedback message from the second device prior to expiration of the first timer, the first device determines that the configuration parameter related to the end-to-end relay service is not successfully configured.

In some embodiments, the second device determines, based on a second timer, whether the configuration parameter related to the end-to-end relay service is successfully configured. The second device may maintain the second timer to determine, based on the second timer, whether the configuration parameter related to the end-to-end relay service is successfully configured. For example, when or after the second device transmits the reconfiguration request message to the first device, the second device starts the second timer. In the case that the second device receives the reconfigured first configuration parameter from the first device prior to expiration of the second timer, the second device determines that the configuration parameter related to the end-to-end relay service is successfully configured. Otherwise, in the case that the second device does not receive the reconfigured first configuration parameter from the first device in expiration of the first timer, the second device determines that the configuration parameter related to the end-to-end relay service is not successfully configured.

In the embodiments, for the end-to-end relay service, a terminal device transmits the configuration parameter related to the service to other terminal devices participating in the end-to-end relay, such that the configuration parameter is synchronously negotiated in service participants to improve the stability and reliability of the end-to-end relay service.

In addition, in response to receiving the first configuration parameter from the first device, the second device transmits the reconfiguration request message to the first device in response to rejection of the first configuration parameter, such that the first device is triggered to reconfigure the parameter to achieve negotiation. In addition, the reconfiguration request message carries the second configuration parameter expected or supported by the second device, such that the first device reconfigures the first configuration parameter based on the second configuration parameter. Thus, the accuracy of parameter configuration is improved, the negotiation process between devices is simplified, and the efficiency of parameter configuration is improved.

In some embodiments, the first configuration parameter includes at least one of the following parameters 1 to 4.

The parameter 1: a first QoS parameter.

The first QoS parameter includes an end-to-end QoS parameter between the first remote terminal device and the second remote terminal device.

Illustratively, the first QoS parameter includes an end-to-end QoS parameter for service transmission from the first remote terminal device to the second remote terminal device and/or an end-to-end QoS parameter for service transmission from the second remote terminal device to the first remote terminal device.

The parameter 2: a first SRAP configuration parameter.

The first SRAP configuration parameter includes an SRAP configuration parameter between the first remote terminal device and the second remote terminal device.

Illustratively, the first SRAP configuration parameter includes an SRAP configuration parameter for service transmission from the first remote terminal device to the second remote terminal device and/or an SRAP configuration parameter for service transmission from the second remote terminal device to the first remote terminal device.

The parameter 3: a second QoS parameter.

The second QoS parameter includes QoS parameter between the first remote terminal device and the relay terminal device.

Illustratively, the second QoS parameter includes a QoS parameter for service transmission from the first remote terminal device to the relay terminal device and/or a QoS parameter for service transmission from the relay terminal device to the first remote terminal device.

The parameter 4: a third QoS parameter.

The third QoS parameter includes a QoS parameter between the second remote terminal device and the relay terminal device.

Illustratively, the third QoS parameter includes a QoS parameter for service transmission from the relay terminal device to the second remote terminal device and/or a QoS parameter for service transmission from the second remote terminal device to the relay terminal device.

In some embodiments, the first configuration parameter includes at least one of the following parameters 1 to 4.

The parameter 1: the first QoS parameter. The first QoS parameter includes an end-to-end QoS parameter for service transmission from the first remote terminal device to the second remote terminal device.

The parameter 2: the first SRAP configuration parameter. The first SRAP configuration parameter includes an SRAP configuration parameter for service transmission from the first remote terminal device to the second remote terminal device.

The parameter 3: the second QoS parameter. The second QoS parameter includes a QoS parameter for service transmission from the first remote terminal device to the relay terminal device.

The parameter 4: the third QoS parameter. The third QoS parameter includes a QoS parameter for service transmission from the relay terminal device to the second remote terminal device.

In the case that the first configuration parameter includes at least one of the above parameters 1 to 4, the first device and the second device are configured in any of the following cases 1 to 5:
the case 1: the first device is the source remote terminal device, and the second device is the target remote terminal device and/or the relay terminal device;
the case 2: the first device is the target remote terminal device, and the second device is the source remote terminal device and/or the relay terminal device;
the case 3: the first device is the relay terminal device, and the second device is the source remote terminal device and/or the target remote terminal device;
the case 4: the first device is the transmitter terminal device, and the second device is the receiver terminal device and/or the relay terminal device; and
the case 5: the first device is the receiver terminal device, and the second device is the transmitter terminal device and/or the relay terminal device.

The source remote terminal device, the target remote terminal device, the transmitter terminal device, and the receiver terminal device involved in the cases 1 to 5 are described in the above embodiments, which are not repeated herein.

Using the case 1 as an example, the source remote terminal device transmits the first configuration parameter related to the end-to-end relay service to the target remote terminal device and/or the relay terminal device, and the first configuration parameter includes at least one of the following parameters 1 to 4.

The parameter 1: the first QoS parameter. The first QoS parameter includes an end-to-end QoS parameter for service transmission from the source remote terminal device to the target remote terminal device.

The parameter 2: the first SRAP configuration parameter. The first SRAP configuration parameter includes an SRAP configuration parameter for service transmission from the source remote terminal device to the target remote terminal device.

The parameter 3: the second QoS parameter. The second QoS parameter includes a QoS parameter for service transmission from the source remote terminal device to the relay terminal device.

The parameter 4: the third QoS parameter. The third QoS parameter includes a QoS parameter for service transmission from the relay terminal device to the target remote terminal device.

Based on the above method, the source remote terminal device (or the network device of the source remote terminal device) configures at least one of the end-to-end QoS parameter, the SRAP configuration parameter, or the per-hop QoS parameter, and synchronizes the parameter to other terminal devices participating in the end-to-end relay.

Using the case 2 as an example, the target remote terminal device transmits the first configuration parameter related to the end-to-end relay service to the source remote terminal device and/or the relay terminal device, and the first configuration parameter includes at least one of the following parameters 1 to 4.

The parameter 1: the first QoS parameter. The first QoS parameter includes an end-to-end QoS parameter for service transmission from the target remote terminal device to the source remote terminal device.

The parameter 2: the first SRAP configuration parameter. The first SRAP configuration parameter includes an SRAP configuration parameter for service transmission from the target remote terminal device to the source remote terminal device.

The parameter 3: the second QoS parameter. The second QoS parameter includes a QoS parameter for service transmission from the target remote terminal device to the relay terminal device.

The parameter 4: the third QoS parameter. The third QoS parameter includes a QoS parameter for service transmission from the relay terminal device to the source remote terminal device.

Based on the above method, the target remote terminal device (or the network device of the target remote terminal device) configures at least one of the end-to-end QoS parameter, the SRAP configuration parameter, or the per-hop QoS parameter, and synchronizes the parameter to other terminal devices participating in the end-to-end relay.

Using the case 3 as an example, the relay terminal device transmits the first configuration parameter related to the end-to-end relay service to the source remote terminal device and/or the target remote terminal device, and the first configuration parameter includes at least one of the following parameters 1 to 4.

The parameter 1: the first QoS parameter. The first QoS parameter includes an end-to-end QoS parameter for service transmission from the source remote terminal device to the target remote terminal device.

The parameter 2: the first SRAP configuration parameter. The first SRAP configuration parameter includes an SRAP configuration parameter for service transmission from the source remote terminal device to the target remote terminal device.

The parameter 3: the second QoS parameter. The second QoS parameter includes a QoS parameter for service transmission from the source remote terminal device to the relay terminal device.

The parameter 4: the third QoS parameter. The third QoS parameter includes a QoS parameter for service transmission from the relay terminal device to the target remote terminal device.

Using the case 3 as an example, the relay terminal device transmits the first configuration parameter related to the end-to-end relay service to the source remote terminal device and/or the target remote terminal device, and the first configuration parameter includes at least one of the following parameters 1 to 4.

The parameter 1: the first QoS parameter. The first QoS parameter includes an end-to-end QoS parameter for service transmission from the target remote terminal device to the source remote terminal device.

The parameter 2: the first SRAP configuration parameter. The first SRAP configuration parameter includes an SRAP configuration parameter for service transmission from the target remote terminal device to the source remote terminal device.

The parameter 3: the second QoS parameter. The second QoS parameter includes a QoS parameter for service transmission from the target remote terminal device to the relay terminal device.

The parameter 4: the third QoS parameter. The third QoS parameter includes a QoS parameter for service transmission from the relay terminal device to the source remote terminal device.

Using the case 3 as an example, the relay terminal device transmits the first configuration parameter related to the end-to-end relay service to the source remote terminal device and/or the target remote terminal device, and the first configuration parameter includes at least one of the following parameters 1 to 4.

The parameter 1: the first QoS parameter. The first QoS parameter includes an end-to-end QoS parameter for service transmission from the transmitter terminal device to the receiver terminal device.

The parameter 2: the first SRAP configuration parameter. The first SRAP configuration parameter includes an SRAP configuration parameter for service transmission from the transmitter terminal device to the receiver terminal device.

The parameter 3: the second QoS parameter. The second QoS parameter includes a QoS parameter for service transmission from the transmitter terminal device to the relay terminal device.

The parameter 4: the third QoS parameter. The third QoS parameter includes a QoS parameter for service transmission from the relay terminal device to the receiver terminal device.

Based on the above method, the relay terminal device (or the network device of the relay terminal device) configures at least one of the end-to-end QoS parameter, the SRAP configuration parameter, or the per-hop QoS parameter, and synchronizes the parameter to other terminal devices participating in the end-to-end relay.

Using the case 4 as an example, the transmitter terminal device transmits the first configuration parameter related to the end-to-end relay service to the receiver terminal device and/or the relay terminal device, and the first configuration parameter includes at least one of the following parameters 1 to 4.

The parameter 1: the first QoS parameter. The first QoS parameter includes an end-to-end QoS parameter for service transmission from the transmitter terminal device to the receiver terminal device.

The parameter 2: the first SRAP configuration parameter. The first SRAP configuration parameter includes an SRAP configuration parameter for service transmission from the transmitter terminal device to the receiver terminal device.

The parameter 3: the second QoS parameter. The second QoS parameter includes a QoS parameter for service transmission from the transmitter terminal device to the relay terminal device.

The parameter 4: the third QoS parameter. The third QoS parameter includes a QoS parameter for service transmission from the relay terminal device to the receiver terminal device.

Based on the above method, the transmitter terminal device (or the network device of the transmitter terminal device) configures at least one of the end-to-end QoS parameter, the SRAP configuration parameter, or the per-hop QoS parameter, and synchronizes the parameter to other terminal devices participating in the end-to-end relay.

Using the case 5 as an example, the receiver terminal device transmits the first configuration parameter related to the end-to-end relay service to the transmitter terminal device and/or the relay terminal device, and the first configuration parameter includes at least one of the following parameters 1 to 4.

The parameter 1: the first QoS parameter. The first QoS parameter includes an end-to-end QoS parameter for service transmission from the transmitter terminal device to the receiver terminal device.

The parameter 2: the first SRAP configuration parameter. The first SRAP configuration parameter includes an SRAP configuration parameter for service transmission from the transmitter terminal device to the receiver terminal device.

The parameter 3: the second QoS parameter. The second QoS parameter includes a QoS parameter for service transmission from the transmitter terminal device to the relay terminal device.

The parameter 4: the third QoS parameter. The third QoS parameter includes a QoS parameter for service transmission from the relay terminal device to the receiver terminal device.

Based on the above method, the receiver terminal device (or the network device of the receiver terminal device) configures at least one of the end-to-end QoS parameter, the SRAP configuration parameter, or the per-hop QoS parameter, and synchronizes the parameter to other terminal devices participating in the end-to-end relay.

In addition, the first configuration parameter in the above cases is exemplary and for explanatory description, and the present disclosure does not limit other combinations of the above cases and the first configuration parameter, which all fall within the scope of protection of the present disclosure.

In some embodiments, as shown in FIG. 5, using negotiation and synchronization of the end-to-end QoS parameter as an example, the method includes at least one of S510 to S540.

In S510, a first remote terminal device transmits a first QoS parameter to a relay terminal device, wherein the first QoS parameter includes an end-to-end QoS parameter for service transmission from the first remote terminal device to the second remote terminal device.

In some embodiments, as shown in FIG. 5, in the case that the first remote terminal device is in an RRC connected state, S510 further includes S502: receiving, by the first remote terminal device, the first QoS parameter from a network device of the first remote terminal device. That is, the network device of the first remote terminal device determines the first QoS parameter and transmits the first QoS parameter to the first remote terminal device.

In S520, the relay terminal device transmits a feedback message acceptance or rejection of the first QoS parameter by the relay terminal device to the first remote terminal device.

In some embodiments, as shown in FIG. 5, in the case that the relay terminal device is in an RRC connected state, S520 further includes S512: transmitting, by the relay terminal device, a request message requesting to determine whether to accept the first QoS parameter to a network device of the relay terminal device; and further includes S514: receiving, by the relay terminal device, a response message indicating acceptance or rejection of the first QoS parameter from the network device of the relay terminal device.

In S530, the first remote terminal device transmits the first QoS parameter to a second remote terminal device by the relay terminal device.

In some embodiments, the relay terminal device forwards the received first QoS parameter to the second remote terminal device.

In S540, the second remote terminal device transmits a feedback message acceptance or rejection of the first QoS parameter by the second remote terminal device to the first remote terminal device by the relay terminal device.

In some embodiments, as shown in FIG. 5, in the case that the second remote terminal device is in an RRC connected state, S540 further includes S532: transmitting, by the second remote terminal device, a request message requesting to determine whether to accept the first QoS parameter to a network device of the second remote terminal device; and further includes S534: receiving, by the second remote terminal device, a response message indicating acceptance or rejection of the first QoS parameter from the network device of the second remote terminal device.

In some embodiments, in the case that the first QoS parameter is only transmitted to either of the relay terminal device and the second remote terminal device, the end-to-end QoS parameter are configured in the case that the terminal device receiving the first QoS parameter accepts the first QoS parameter, and the end-to-end QoS parameter is reconfigured in the case that the terminal device receiving the first QoS parameter rejects the first QoS parameter.

In some embodiments, in the case that the first QoS parameter is transmitted to the relay terminal device and the second remote terminal device, the end-to-end QoS parameter is configured in the case that the relay terminal device and the second remote terminal device both accept the first QoS parameter, and the end-to-end QoS parameter is reconfigured in the case that at least one of the relay terminal device and the second remote terminal device rejects the first QoS parameter.

In the above method, for the end-to-end relay service, the service transmitter configures the end-to-end QoS parameter and synchronizes the end-to-end QoS parameter to other terminal devices participating in the end-to-end relay, such that the QoS parameter is synchronously negotiated in service participants to improve the stability and reliability of the end-to-end relay service.

In some embodiments, for the SRAP configuration parameter, after the first device and the second device negotiate to determine the end-to-end QoS parameter, the first device and/or the second device respectively transmit QoS configuration information to the network device thereof, and the network devices configure the SRAP configuration parameter based on the QoS configuration information and transmit the configured SRAP configuration parameter to the first device and/or the second device. The QoS configuration information includes at least one of the end-to-end QoS parameter or the per-hop QoS parameter.

In the above method, the network terminal configures the SRAP configuration parameter for the terminal device.

In some embodiments, the first configuration parameter includes at least one of the following parameters 5 to 6.

The parameter 5: the first PDCP configuration parameter.

The first PDCP configuration parameter includes a PDCP configuration parameter between the first remote terminal device and the second remote terminal device.

Illustratively, the first PDCP configuration parameter includes a PDCP configuration parameter for service transmission from the first remote terminal device to the second remote terminal device and/or a PDCP configuration parameter for service transmission from the second remote terminal device to the first remote terminal device.

The parameter 6: the first SDAP configuration parameter.

The first SDAP configuration parameter includes an SDAP configuration parameter between the first remote terminal device and the second remote terminal device.

Illustratively, the first SDAP configuration parameter include an SDAP configuration parameter for service transmission from the first remote terminal device to the second remote terminal device and/or an SDAP configuration parameter for service transmission from the second remote terminal device to the first remote terminal device.

In some embodiments, the first configuration parameter includes at least one of the following parameters 5 to 6.

The parameter 5: the first PDCP configuration parameter. The first PDCP configuration parameter includes a PDCP configuration parameter for service transmission from the first remote terminal device to the second remote terminal device.

The parameter 6: the first SDAP configuration parameter. The first SDAP configuration parameter includes an SDAP configuration parameter from the first remote terminal device to the second remote terminal device.

In the case that the first configuration parameter includes at least one of the above parameters 5 to 6, the first device and the second device are configured in any of the following cases 7 to 9:
the case 7: the first device is the source remote terminal device, and the second device is the target remote terminal device;
the case 8: the first device is the target remote terminal device, and the second device is the source remote terminal device; and
the case 9: the first device is the transmitter terminal device, and the second device is the receiver terminal device.

The source remote terminal device, the target remote terminal device, the transmitter terminal device, and the receiver terminal device involved in the cases 7 to 9 are described in the above embodiments, which are not repeated herein.

Using the case 7 as an example, the source remote terminal device transmits the first configuration parameter related to the end-to-end relay service to the target remote terminal device, and the first configuration parameter includes at least one of the following parameters 5 to 6.

The parameter 5: the first PDCP configuration parameter. The first PDCP configuration parameter includes a PDCP configuration parameter for service transmission from the source remote terminal device to the target remote terminal device.

The parameter 6: the first SDAP configuration parameter. The first SDAP configuration parameter includes an SDAP configuration parameter from the source remote terminal device to the target remote terminal device.

Based on the above method, the source remote terminal device (or the network device of the source remote terminal device) configures at least one of the PDCP configuration parameter or the SDAP configuration parameter, and synchronizes the parameter to a peer remote terminal device participating in the end-to-end relay.

Using the case 8 as an example, the target remote terminal device transmits the first configuration parameter related to the end-to-end relay service to the source remote terminal device, and the first configuration parameter includes at least one of the following parameters 5 to 6.

The parameter 5: the first PDCP configuration parameter. The first PDCP configuration parameter includes a PDCP configuration parameter for service transmission from the target remote terminal device to the source remote terminal device.

The parameter 6: the first SDAP configuration parameter. The first SDAP configuration parameter includes an SDAP configuration parameter from the target remote terminal device to the source remote terminal device.

Based on the above method, the target remote terminal device (or the network device of the target remote terminal device) configures at least one of the PDCP configuration parameter or the SDAP configuration parameter, and synchronizes the parameter to a peer remote terminal device participating in the end-to-end relay.

Using the case 9 as an example, the transmitter terminal device transmits the first configuration parameter related to the end-to-end relay service to the receiver terminal device, and the first configuration parameter includes at least one of the following parameters 5 to 6.

The parameter 5: the first PDCP configuration parameter. The first PDCP configuration parameter includes a PDCP configuration parameter for service transmission from the transmitter terminal device to the receiver terminal device.

The parameter 6: the first SDAP configuration parameter. The first SDAP configuration parameter includes an SDAP configuration parameter from the transmitter terminal device to the receiver terminal device.

Based on the above method, the transmitter terminal device (or the network device of the transmitter terminal device) configures at least one of the PDCP configuration parameter or the SDAP configuration parameter, and synchronizes the parameter to a peer remote terminal device participating in the end-to-end relay.

In some embodiments, the first configuration parameter includes at least one of the following parameters 7 to 8.

The parameter 7: the first RLC configuration parameter.

The first RLC configuration parameter includes an RLC configuration parameter of a first sidelink between the first remote terminal device and the relay terminal device.

Illustratively, the first RLC configuration parameter includes an RLC configuration parameter for service transmission from the first remote terminal device to the relay terminal device and/or an RLC configuration parameter for service transmission from the relay terminal device to the first remote terminal device.

The parameter 8: the second RLC configuration parameter.

The second RLC configuration parameter includes an RLC configuration parameter of a second sidelink between the second remote terminal device and the relay terminal device.

Illustratively, the second RLC configuration parameter includes an RLC configuration parameter for service transmission from the second remote terminal device to the relay terminal device and/or an RLC configuration parameter for service transmission from the relay terminal device to the second remote terminal device.

In the case that the first configuration parameter includes at least one of the above parameters 7 to 8, the first device and the second device are configured in any of the following cases 10 to 11:
the case 10: the first device is a transmitter on the first sidelink, and the second device is a receiver on the first sidelink and/or a receiver on the second sidelink; and
the case 11: the first device is a transmitter on the second sidelink, and the second device is a receiver on the second sidelink and/or a receiver of the first sidelink.

In the case that the transmitter on the first sidelink is the first remote terminal device, the receiver on the first sidelink is the relay terminal device. In the case that the transmitter on the first sidelink is the relay terminal device, the receiver on the first sidelink is the first remote terminal device. In the case that the transmitter on the second sidelink is the second remote terminal device, the receiver on the second sidelink is the relay terminal device. In the case that the transmitter on the second sidelink is the relay terminal device, the receiver on the second sidelink is the second remote terminal device.

Using the case 10 as an example, assuming that the transmitter on the first sidelink is the first remote terminal device, the receiver on the first sidelink is the relay terminal device, the transmitter on the second sidelink is the relay terminal device, and the receiver on the second sidelink is the second remote terminal device, then the first remote terminal device transmits the first configuration parameter related to the end-to-end relay service to the relay terminal device, and the first configuration parameter includes the RLC configuration parameter of the first sidelink between the first remote terminal device and the relay terminal device. In some embodiments, the first configuration parameter further includes the RLC configuration parameter of the second sidelink between the relay terminal device and the second remote terminal device. In some embodiments, in the case that the first configuration parameter further includes the RLC configuration parameter of the second sidelink, the relay terminal device transmits the RLC configuration parameter of the second sidelink to the second remote terminal device.

Using the case 10 as an example, assuming that the transmitter on the first sidelink is the relay terminal device, and the receiver on the first sidelink is the first remote terminal device, then the relay terminal device transmits the first configuration parameter related to the end-to-end relay service to the first remote terminal device, and the first configuration parameter includes the RLC configuration parameter of the first sidelink between the first remote terminal device and the relay terminal device.

Using the case 11 as an example, assuming that the transmitter on the second sidelink is the second remote terminal device, the receiver on the second sidelink is the relay terminal device, the transmitter on the first sidelink is the relay terminal device, and the receiver on the first sidelink is the first remote terminal device, then the second remote terminal device transmits the first configuration parameter related to the end-to-end relay service to the relay terminal device, and the first configuration parameter includes the RLC configuration parameter of the second sidelink between the second remote terminal device and the relay terminal device. In some embodiments, the first configuration parameter further includes the RLC configuration parameter of the first sidelink between the relay terminal device and the first remote terminal device. In some embodiments, in the case that the first configuration parameter further includes the RLC configuration parameter of the first sidelink, the relay terminal device transmits the RLC configuration parameter of the first sidelink to the first remote terminal device.

Using the case 11 as an example, assuming that the transmitter on the second sidelink is the relay terminal device, and the receiver on the second sidelink is the second remote terminal device, then the relay terminal device transmits the first configuration parameter related to the end-to-end relay service to the second remote terminal device, and the first configuration parameter includes the RLC configuration parameter of the first sidelink between the second remote terminal device and the relay terminal device.

In some embodiments, in the case that the first device is in an RRC connected state, the network device of the first device configures the first RLC configuration parameter and/or the second RLC configuration parameter and transmits the parameter to the first device over an RRC specific signaling. In the case that the first device is in an RRC idle state or an RRC non-activated state, the network device of the first device configures the first RLC configuration parameter and/or the second RLC configuration parameter and transmits the parameter to the first device over a system broadcast message.

In some embodiments, in the case that the second device is in an RRC connected state, the second device reports the received first RLC configuration parameter and/or second RLC configuration parameter to the network device of the second device over an RRC specific signaling, and the network device of the second device determines whether to accept or reject the first RLC configuration parameter and/or the second RLC configuration parameter.

In the above method, for the end-to-end relay scenario, the per-hop RLC configuration parameter of the sidelink between the remote terminal device and the relay terminal device is configured by the transmitter on the current sidelink or the transmitter on the other sidelink, such that the RLC configuration is flexible.

In some embodiments, the first configuration parameter includes the first QoS parameter. The first QoS parameter includes an end-to-end QoS parameter between the first remote terminal device and the second remote terminal device. In response to receiving the above first configuration parameter, the second device transmits the per-hop QoS parameter to the first device. Accordingly, the first device receives the per-hop QoS parameter from the second device. The per-hop QoS parameter includes a second QoS parameter and/or a third QoS parameter. The second QoS parameter include a QoS parameter between the first remote terminal device and the relay terminal device, and the third QoS parameter includes a QoS parameter between the second remote terminal device and the relay terminal device.

In some embodiments, the first configuration parameter includes the first QoS parameter. The first QoS parameter includes an end-to-end QoS parameter for service transmission from the first remote terminal device to the second remote terminal device. In response to receiving the first configuration parameter, the second device transmits the per-hop QoS parameter to the first device. Accordingly, the first device receives the per-hop QoS parameter from the second device. The per-hop QoS parameter includes a second QoS parameter and/or a third QoS parameter. The second QoS parameter includes a QoS parameter for service transmission from the first remote terminal device to the relay terminal device, and the third QoS parameter includes a QoS parameter for service transmission from the relay terminal device to the second remote terminal device.

In addition, the first device and the second device are configured in any of the above cases 1 to 5.

In some embodiments, the per-hop QoS parameter is determined by the second device. That is, the second device configures the per-hop QoS parameter.

In some embodiments, the per-hop QoS parameter is determined by the network device of the second device. That is, the network device of the second device configures the per-hop QoS parameter. For example, the per-hop QoS parameter is determined by an access network device (example, a station) of the second device. The network device of the second device transmits the per-hop QoS parameter to the second device, and the second device transmits the per-hop QoS parameter to the first device. For example, the network device of the second device transmits the per-hop QoS parameter to the second device over an RRC message.

In some embodiments, in the case that the second device is in an RRC connected state, the per-hop QoS parameter is determined by the network device of the second device or by the second device.

In some embodiments, in the case that the second device is in a non-connected state, for example, in the case that the second device is in an RRC idle state or an RRC non-activated state, the per-hop QoS parameter is determined by the second device.

In some embodiments, in response to receiving the per-hop QoS parameter from the second device, the first device determines whether to accept the per-hop QoS parameter.

In some embodiments, in response to receiving the per-hop QoS parameter from the second device, the first device transmits a request message to the network device of the first device, wherein the request message requests to determine whether to accept the per-hop QoS parameter; and the first device receives the response message from the network device of the first device, wherein the response message indicates acceptance or rejection of the per-hop QoS parameter.

In some embodiments, in the case that the first device is in an RRC connected state, whether to accept the per-hop QoS parameter from the second device is determined by the network device of the first device or by the first device.

In some embodiments, in the case that the first device is in a non-connected state, for example, in the case that the first device is in an RRC idle state or an RRC non-activated state, whether to accept the per-hop QoS parameter from the second device is determined by the first device.

In some embodiments, in response to acceptance of the per-hop QoS parameter from the second device, the first device transmits a feedback message instructing to accept the per-hop QoS parameter to the second device; and in response to rejection of the per-hop QoS parameter from the second device, the first device transmits a feedback message instructing to reject or reconfigure the per-hop QoS parameter to the second device.

In some embodiments, in response to rejection of the per-hop QoS parameter from the second device, the first device further transmits a suggested per-hop QoS parameter to the second device, such that the second device reconfigures based on the suggested per-hop QoS parameter to improve negotiation efficiency of the per-hop QoS parameter.

In the above method, for the end-to-end relay service, the receiver of the end-to-end QoS parameter performs the QoS segment to configure the per-hop QoS parameter. In addition, the per-hop QoS parameter is synchronously negotiated in a plurality of terminal devices participating in the end-to-end relay service.

In some embodiments, in the case that the first device is the relay terminal device and is beyond a network coverage, the method further includes: selecting configuration information corresponding to a bearer based on a selection priority of each set of configuration information in a case that a same bearer corresponds to a plurality of sets of QoS parameters and each set of the plurality of sets of QoS parameters corresponds to a set of configuration information, wherein the configuration information includes at least one of an SRAP configuration parameter or an RLC configuration parameter, and the selection priority is correlated with at least one of a PC5 5G QoS identifier (PQI) in each of the plurality of sets of QoS parameters, a PDB in each of the plurality of sets of QoS parameters, or explicit priority information.

In the case that the SRAP and/or RLC configuration parameter is configured with the end-to-end QoS parameter as granularity, the QoS parameters are in one-to-one mapping with the SRAP and/or RLC configuration parameters but are in a multiple-to-one mapping with the bearer configuration. That is, a same bearer corresponds to a plurality of sets of QoS parameters and a plurality of sets of SRAP and/or RLC configuration parameters. Thus, in the case that the relay terminal device selects the SRAP and/or RLC configuration parameter based on the bearer identifier (ID), a plurality of sets of SRAP and/or RLC configuration parameters are for selection. In this case, additional criteria are required to assist the relay terminal device in selecting the appropriate SRAP and/or RLC configuration parameter corresponding to the bearer. In some embodiments, the criteria are at least one of the following methods.

(1) The selection is performed based on the PQI in the QoS parameter. That is, the lower the PQI value, the higher the priority of the corresponding SRAP and/or RLC configuration parameter. Thus, the corresponding SRAP and/or RLC configuration parameter are prioritized.

(2) The selection is performed based on the PDB in the QoS parameter. That is, the lower the PDB value, the higher the priority of the corresponding SRAP and/or RLC configuration parameter. Thus, the corresponding SRAP and/or RLC configuration parameter are prioritized.

(3) The explicit priority information is added. The priority information indicates the priority of the corresponding SRAP and/or RLC configuration parameter, and the SRAP and/or RLC configuration parameter with a higher priority are selected.

In some embodiments, in the case that several sets of SRAP and/or RLC configuration parameters are selected based on the above criteria, one set of SRAP and/or RLC configuration parameters is selected based on implementation of the terminal.

In the above method, how to deduce the SRAP and/or RLC configuration parameter based on end-to-end QoS information by the relay terminal device beyond the coverage is clear.

In some embodiments, different PDB levels correspond to different pieces of configuration information, and each PDB level corresponds to a PDB value range.

For the PDB greatly affected by the QoS segment, the PDB may affect configuration of the related SRAP and/or RLC configuration parameters. However, the PDB ranges from 0 to 1023, the granularity is excessively fine in the case that the 1024 PDBs are respectively configured with the SRAP and/or RLC configuration parameters. Thus, the PDBs in different levels are configured with the SRAP and/or RLC parameters in the following method.

In some embodiments, the 1024 PDB values are leveled, the level segment includes a first number of PDB levels, and the levels are in one-to-multiple correspondence to the true value of the PDB. Furthermore, the corresponding SRAP and/or RLC configuration parameters are configured for the PDB level, and the related SRAP and/or RLC configuration parameters carry the PDB level information. The relay terminal device may determine the corresponding PDB level based on the PDB value information, and then select the corresponding SRAP and/or RLC configuration parameters.

In the above method, how to deduce the SRAP and/or RLC configuration parameter based on QoS segment information by the relay terminal device beyond the coverage is clear.

The following embodiments are apparatus embodiments of the present disclosure, which are applicable to the method embodiments of the present disclosure. For details not shown in the apparatus embodiments of the present disclosure, reference may be made to the method embodiments of the present disclosure.

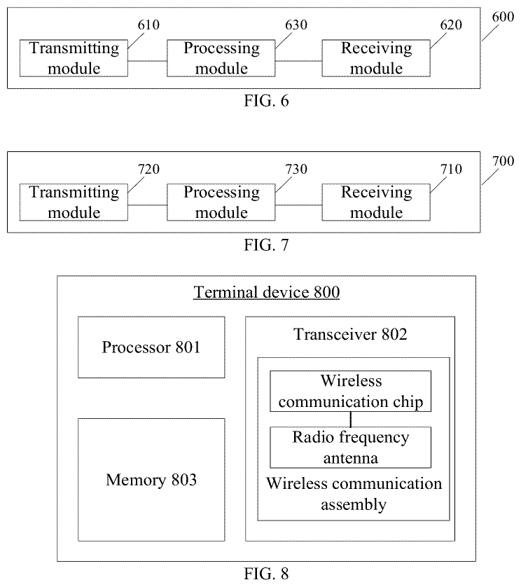

Referring to FIG. 6, FIG. 6 is a block diagram of a communication apparatus according to some embodiments of the present disclosure. The apparatus functions to perform the communication method applicable to the first device, and the function is implemented by hardware, or by executing the corresponding software by hardware. The apparatus is the first device described above or is disposed in the first device. As shown in FIG. 6, the apparatus 600 includes a transmitting module 610.

The transmitting module 610 is configured to transmit a first configuration parameter related to the end-to-end relay service to a second device in the end-to-end relay service.

In some embodiments, a first remote terminal device, a relay terminal device, and a second remote terminal device participate in the end-to-end relay service, and the first configuration parameter includes at least one of:
an end-to-end configuration parameter, wherein the end-to-end configuration parameter includes a configuration parameter for service transmission between the first remote terminal device and the second remote terminal device;
a first per-hop configuration parameter, wherein the first per-hop configuration parameter includes a configuration parameter for service transmission between the first remote terminal device and the relay terminal device; or
a second per-hop configuration parameter, wherein the second per-hop configuration parameter includes a configuration parameter for service transmission between the second remote terminal device and the relay terminal device.

In some embodiments, the end-to-end configuration parameter includes at least one of:
a first parameter, wherein the first parameter includes a configuration parameter for service transmission from the first remote terminal device to the second remote terminal device; or
a second parameter, wherein the second parameter includes a configuration parameter for service transmission from the second remote terminal device to the first remote terminal device.

In some embodiments, the first per-hop configuration parameter includes at least one of:
a third parameter, wherein the third parameter includes a configuration parameter for service transmission from the first remote terminal device to the relay terminal device; or
a fourth parameter, wherein the fourth parameter includes a configuration parameter for service transmission from the relay terminal device to the first remote terminal device.

In some embodiments, the second per-hop configuration parameter includes at least one of:
a fifth parameter, wherein the fifth parameter includes a configuration parameter for service transmission from the second remote terminal device to the relay terminal device; or
a sixth parameter, wherein the sixth parameter includes a configuration parameter for service transmission from the relay terminal device to the second remote terminal device.

In some embodiments, the first device acts as a remote terminal device of a service transmitter, and the second device acts as a remote terminal device and/or a relay terminal device of a service receiver;
the first device acts as a remote terminal device of a service receiver, and the second device acts as a remote terminal device and/or a relay terminal device of a service transmitter;
the first device acts as a relay terminal device of a service transmitter, and the second device acts as a remote terminal device of a service receiver; or
the first device acts as a relay terminal device of a service receiver, and the second device acts as a remote terminal device of a service transmitter.

In some embodiments, the first configuration parameter includes at least one of an end-to-end QoS parameter, an end-to-end SRAP configuration parameter, an end-to-end PDCP configuration parameter, an end-to-end SDAP configuration parameter, per-hop QoS parameter, or a per-hop RLC configuration parameter.

In some embodiments, the first configuration parameter is determined by the first device, or, the first configuration parameter is determined by a network device of the first device.

In some embodiments, as shown in FIG. 6, the apparatus 600 further includes a receiving module 620, configured to receive a reconfiguration request message from the second device in response to rejection of the first configuration parameter, wherein the reconfiguration request message requests to reconfigure the first configuration parameter.

In some embodiments, the reconfiguration request message includes a second configuration parameter related to the end-to-end relay service, wherein the second configuration parameter is determined by the second device, or, the second configuration parameter is determined by a network device of the second device.

In some embodiments, the transmitting module is further configured to transmit a reconfigured first configuration parameter to the second device.

In some embodiments, as shown in FIG. 6, the apparatus 600 further includes a processing module 630, configured to determine, based on a first timer, whether the configuration parameter related to the end-to-end relay service is successfully configured.

In some embodiments, the first device is a relay terminal device in the end-to-end relay service and is beyond a network coverage, and the apparatus 600 further includes a processing module 630, configured to select configuration information corresponding to a bearer based on a selection priority of each set of configuration information in a case that a same bearer corresponds to a plurality of sets of QoS parameters and each set of the plurality of sets of QoS parameters corresponds to a set of configuration information, wherein the configuration information includes at least one of SRAP configuration parameters or RLC configuration parameters, and the selection priority is correlated with at least one of a PQI in each of the plurality of sets of QoS parameters, a PDB in each of the plurality of sets of QoS parameters, or explicit priority information.

In some embodiments, different PDB levels correspond to different pieces of configuration information, and each PDB level corresponds to a PDB value range.

Referring to FIG. 7, FIG. 7 is a block diagram of a communication apparatus according to some embodiments of the present disclosure. The apparatus functions to perform the communication method applicable to the second device, and the function is implemented by hardware, or by executing the corresponding software by hardware. The apparatus is the second device described above or is disposed in the second device. As shown in FIG. 7, the apparatus 700 includes a receiving module 710.

The receiving module 710 is configured to receive a first configuration parameter related to the end-to-end relay service from a first device in the end-to-end relay service.

In some embodiments, a first remote terminal device, a relay terminal device, and a second remote terminal device participate in the end-to-end relay service, and the first configuration parameter includes at least one of:
an end-to-end configuration parameter, wherein the end-to-end configuration parameter includes a configuration parameter for service transmission between the first remote terminal device and the second remote terminal device;
a first per-hop configuration parameter, wherein the first per-hop configuration parameter includes a configuration parameter for service transmission between the first remote terminal device and the relay terminal device; or
a second per-hop configuration parameter, wherein the second per-hop configuration parameter include a configuration parameter for service transmission between the second remote terminal device and the relay terminal device.

In some embodiments, the end-to-end configuration parameter includes at least one of:
a first parameter, wherein the first parameter includes a configuration parameter for service transmission from the first remote terminal device to the second remote terminal device; or
a second parameter, wherein the second parameter includes a configuration parameter for service transmission from the second remote terminal device to the first remote terminal device.

In some embodiments, the first per-hop configuration parameter includes at least one of:
a third parameter, wherein the third parameter includes a configuration parameter for service transmission from the first remote terminal device to the relay terminal device; or
a fourth parameter, wherein the fourth parameter includes a configuration parameter for service transmission from the relay terminal device to the first remote terminal device.

In some embodiments, the second per-hop configuration parameter includes at least one of:
a fifth parameter, wherein the fifth parameter includes a configuration parameter for service transmission from the second remote terminal device to the relay terminal device; or
a sixth parameter, wherein the sixth parameter includes a configuration parameter for service transmission from the relay terminal device to the second remote terminal device.

In some embodiments, the first device acts as a remote terminal device of a service transmitter, and the second device acts as a remote terminal device and/or a relay terminal device of a service receiver;
the first device acts as a remote terminal device of a service receiver, and the second device acts as a remote terminal device and/or a relay terminal device of a service transmitter;
the first device acts as a relay terminal device of a service transmitter, and the second device acts as a remote terminal device of a service receiver; or
the first device acts as a relay terminal device of a service receiver, and the second device acts as a remote terminal device of a service transmitter.

In some embodiments, the first configuration parameter includes at least one of an end-to-end QoS parameter, an end-to-end SRAP configuration parameter, an end-to-end PDCP configuration parameter, an end-to-end SDAP configuration parameter, a per-hop QoS parameter, or a per-hop RLC configuration parameter.

In some embodiments, as shown in FIG. 7, the apparatus 700 further includes a transmitting module 720, configured to transmit a request message to a network device of the second device, wherein the request message requests to determine whether to accept the first configuration parameter; and
the receiving module 710, further configured to receive a response message from the network device of the second device, wherein the response message indicates acceptance or rejection of the first configuration parameter.

In some embodiments, as shown in FIG. 7, the apparatus 700 further includes a transmitting module 720, configured to transmit a reconfiguration request message to the first device in response to rejection of the first configuration parameter, wherein the reconfiguration request message requests to reconfigure the first configuration parameter.

In some embodiments, the reconfiguration request message includes second configuration parameter related to the end-to-end relay service, wherein the second configuration parameter is determined by the second device, or, the second configuration parameter is determined by a network device of the second device.

In some embodiments, the receiving module 710 is further configured to receive a reconfigured first configuration parameter from the first device.

In some embodiments, as shown in FIG. 7, the apparatus 700 further includes a processing module 730, configured to determine, based on a second timer, whether the configuration parameter related to the end-to-end relay service is successfully configured.

In some embodiments, the second device is a relay terminal device in the end-to-end relay service and is beyond a network coverage, and the apparatus 700 further includes: a processing module 730, configured to select configuration information corresponding to a bearer based on a selection priority of each set of configuration information in a case that a same bearer corresponds to a plurality of sets of QoS parameters and each set of the plurality of sets of QoS parameters corresponds to a set of configuration information, wherein the configuration information includes at least one of SRAP configuration parameters or RLC configuration parameters, and the selection priority is correlated with at least one of a PQI in each of the plurality of sets of QoS parameters, a PDB in each of the plurality of sets of QoS parameters, or explicit priority information.

In some embodiments, different PDB levels correspond to different pieces of configuration information, and each PDB level corresponds to a PDB value range.

It should be noted that, in the case that the apparatus according to the above embodiments implements the functions thereof, the division of the functional modules is merely exemplary. In practice, the above functions may be assigned to and completed by different functional modules according to actual needs, that is, the internal structure of the apparatus may be divided into different functional modules, to implement all or a part of the above functions.

With regard to the apparatus in the above embodiments, the specific manner in which each module performs the operation has been described in detail in the embodiments related to the method and will not be described in detail herein. Reference may be made to the above method embodiments for details that are not specified in the apparatus embodiment.

Referring to FIG. 8, a schematic structural diagram of a terminal device according to some embodiments of the present disclosure is illustrated. The terminal device 800 includes: a processor 801, a transceiver 802, and a memory 803.

The processor 801 includes one or more processing cores, and the processor 801 runs various functional applications and performs information processing by running software programs and modules. The processor 801 is configured to implement the functions of the processing module in the above apparatus embodiments.

The transceiver 802 includes a receiver and a transmitter, which are practiced, for example, as the same wireless communication assembly that includes a wireless communication chip and a radio frequency antenna. The transceiver 802 is configured to implement the functions of the transmitting module and/or the receiving module in the above apparatus embodiments.

The memory 803 is connected to the processor 801 and the transceiver 802.

The memory 803 may be configured to store one or more computer programs run by the processor, and the processor 801 is configured to run the one or more computer programs to perform the processes implemented by the first device and/or the second device in the above method embodiments.

In some embodiments, in the case that the terminal device is the first device in the end-to-end relay service, the transceiver 802 is configured to transmit a first configuration parameter related to the end-to-end relay service to a second device in the end-to-end relay service.

In some embodiments, in the case that the terminal device is the second device in the end-to-end relay service, the transceiver 802 is configured to receive a first configuration parameter related to the end-to-end relay service from a first device in the end-to-end relay service.

For details not specified in the embodiments, reference is made to the foregoing embodiments, which are not repeated herein.

In addition, the memory may be implemented by any type or combination of volatile or non-volatile storage devices, including, but not limited to: a magnetic or optical disc, an electrically erasable programmable read-only memory, an erasable programmable read-only memory, a static random-access memory, a read-only memory, a magnetic memory, a flash memory, and a programmable read-only memory.

Some embodiments of the present disclosure further provide a computer-readable storage medium storing one or more computer programs therein. The one or more computer programs, when loaded and run by a processor, cause the processor to perform the communication method applicable to the first device or the communication method applicable to the second device. In some embodiments, the computer-readable storage medium includes: a read-only memory (ROM), a random-access memory (RAM), a solid state drive (SSD), an optical disk, etc. The RAM includes a resistance random-access memory (ReRAM) and a dynamic random access memory (DRAM).

Some embodiments of the present disclosure further provide a chip including one or more programmable logic circuits and/or one or more program instructions. The chip, when running, is caused to perform the communication method applicable to the first device or the communication method applicable to the second device.

Some embodiments of the present disclosure further provide a computer program product. The computer program product includes one or more computer instructions stored in a computer-readable storage medium. The one or more computer instructions, when read from the computer-readable storage medium and executed by a processor, cause the processor to perform the communication method applicable to the first device or the communication method applicable to the second device.

Some embodiments of the present disclosure further provide a communication system_{○} The communication system includes a first device and a second device, wherein the first device is configured to perform the communication method applicable to the first device, and the second device is configured to perform the communication method applicable to the second device.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In some embodiments of the present disclosure, the “protocol” refers to a standard protocol in the communication field including, for example, the LTE protocol, the NR protocol, and related protocols applied in future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A communication method, applicable to a first device in an end-to-end relay service, the method comprising:
transmitting a first configuration parameter related to the end-to-end relay service to a second device in the end-to-end relay service, wherein a first remote terminal device, a relay terminal device, and a second remote terminal device participate in the end-to-end relay service, and the first configuration parameter comprises at least one of:
an end-to-end configuration parameter, wherein the end-to-end configuration parameter comprises a configuration parameter for service transmission between the first remote terminal device and the second remote terminal device;
a first per-hop configuration parameter, wherein the first per-hop configuration parameter comprises a configuration parameter for service transmission between the first remote terminal device and the relay terminal device; or
a second per-hop configuration parameter, wherein the second per-hop configuration parameter comprises a configuration parameter for service transmission between the second remote terminal device and the relay terminal device.

2. The method according to claim 1, wherein:
in a case that the first configuration parameter comprises the end-to-end configuration parameter, the first device acts as the first remote terminal device or the second remote terminal device, and the second device acts as the relay terminal device;
in a case that the first configuration parameter comprises the first per-hop configuration parameter, the first device acts as the relay terminal device, and the second device acts as the first remote terminal device; and
in a case that the first configuration parameter comprises the second per-hop configuration parameter, the first device acts as the relay terminal device, and the second device acts as the second remote terminal device.

3. The method according to claim 1, wherein the end-to-end configuration parameter comprises at least one of:
a first parameter, wherein the first parameter comprises a configuration parameter for service transmission from the first remote terminal device to the second remote terminal device; or
a second parameter, wherein the second parameter comprises a configuration parameter for service transmission from the second remote terminal device to the first remote terminal device.

4. The method according to claim 1, wherein the first per-hop configuration parameter comprises at least one of:
a third parameter, wherein the third parameter comprises a configuration parameter for service transmission from the first remote terminal device to the relay terminal device; or
a fourth parameter, wherein the fourth parameter comprises a configuration parameter for service transmission from the relay terminal device to the first remote terminal device.

5. The method according to claim 1, wherein the second per-hop configuration parameter comprises at least one of:
a fifth parameter, wherein the fifth parameter comprises a configuration parameter for service transmission from the second remote terminal device to the relay terminal device; or
a sixth parameter, wherein the sixth parameter comprises a configuration parameter for service transmission from the relay terminal device to the second remote terminal device.

6. The method according to claim 1, wherein:
the first device acts as a remote terminal device of a service transmitter, and the second device acts as a remote terminal device and/or a relay terminal device of a service receiver;
the first device acts as a remote terminal device of a service receiver, and the second device acts as a remote terminal device and/or a relay terminal device of a service transmitter;
the first device acts as a relay terminal device of a service transmitter, and the second device acts as a remote terminal device of a service receiver; or
the first device acts as a relay terminal device of a service receiver, and the second device acts as a remote terminal device of a service transmitter.

7. The method according to claim 1, wherein the first configuration parameter comprises at least one of an end-to-end quality of service (QoS) parameter, an end-to-end Sidelink Relay Adaptation Protocol (SRAP) configuration parameter, an end-to-end Packet Data Convergence Protocol (PDCP) configuration parameter, an end-to-end Service Data Adaptation Protocol (SDAP) configuration parameter, a per-hop QoS parameter, or a per-hop radio link control (RLC) configuration parameter.

8. The method according to claim 1, wherein the first configuration parameter is determined by the first device, or, the first configuration parameter is determined by a network device of the first device.

9. The method according to claim 1, wherein upon transmitting the first configuration parameter related to the end-to-end relay service to the second device in the end-to-end relay service, the method further comprises:
receiving a reconfiguration request message from the second device in response to rejection of the first configuration parameter, wherein the reconfiguration request message requests to reconfigure the first configuration parameter, and comprises second configuration parameter related to the end-to-end relay service, wherein the second configuration parameter is determined by the second device, or, the second configuration parameter is determined by a network device of the second device; and
transmitting a reconfigured first configuration parameter to the second device.

10. The method according to claim 1, wherein the first device is a relay terminal device in the end-to-end relay service and is beyond a network coverage, and the method further comprises:
selecting configuration information corresponding to a bearer based on a selection priority of each set of configuration information in a case that a same bearer corresponds to a plurality of sets of quality of service (QoS) parameters and each set of the plurality of sets of QoS parameters corresponds to a set of configuration information, wherein the configuration information comprises at least one of Sidelink Relay Adaptation Protocol (SRAP) configuration parameters or radio link control (RLC) configuration parameters, and the selection priority is correlated with at least one of a proximity services communication 5 (PC5) 5G QoS identifier (PQI) in each of the plurality of sets of QoS parameters, a packet delay budget (PDB) in each of the plurality of sets of QoS parameters, or explicit priority information, wherein different PDB levels correspond to different pieces of configuration information, and each PDB level corresponds to a PDB value range.

11. A terminal device, comprising:
a processor and a memory storing one or more computer programs, which when executed by the processor, causes the terminal device to:
transmit a first configuration parameter related to an end-to-end relay service to a second device in the end-to-end relay service, wherein a first remote terminal device, a relay terminal device, and a second remote terminal device participate in the end-to-end relay service, and the first configuration parameter comprises at least one of:
an end-to-end configuration parameter, wherein the end-to-end configuration parameter comprises a configuration parameter for service transmission between the first remote terminal device and the second remote terminal device;
a first per-hop configuration parameter, wherein the first per-hop configuration parameter comprises a configuration parameter for service transmission between the first remote terminal device and the relay terminal device; or
a second per-hop configuration parameter, wherein the second per-hop configuration parameter comprises a configuration parameter for service transmission between the second remote terminal device and the relay terminal device.

12. The terminal device according to claim 11, wherein:
in a case that the first configuration parameter comprises the end-to-end configuration parameter, the terminal device acts as the first remote terminal device or the second remote terminal device, and the second device acts as the relay terminal device;
in a case that the first configuration parameter comprises the first per-hop configuration parameter, the terminal device acts as the relay terminal device, and the second device acts as the first remote terminal device; and
in a case that the first configuration parameter comprises the second per-hop configuration parameter, the terminal device acts as the relay terminal device, and the second device acts as the second remote terminal device.

13. The terminal device according to claim 11, wherein the end-to-end configuration parameter comprises at least one of:
a first parameter, wherein the first parameter comprises a configuration parameter for service transmission from the first remote terminal device to the second remote terminal device; or
a second parameter, wherein the second parameter comprises a configuration parameter for service transmission from the second remote terminal device to the first remote terminal device.

14. The terminal device according to claim 11, wherein the first per-hop configuration parameter comprises at least one of:
a third parameter, wherein the third parameter comprises a configuration parameter for service transmission from the first remote terminal device to the relay terminal device; or
a fourth parameter, wherein the fourth parameter comprises a configuration parameter for service transmission from the relay terminal device to the first remote terminal device.

15. The terminal device according to claim 11, wherein:
the terminal device acts as a remote terminal device of a service transmitter, and the second device acts as a remote terminal device and/or a relay terminal device of a service receiver;
the terminal device acts as a remote terminal device of a service receiver, and the second device acts as a remote terminal device and/or a relay terminal device of a service transmitter;
the terminal device acts as a relay terminal device of a service transmitter, and the second device acts as a remote terminal device of a service receiver; or
the terminal device acts as a relay terminal device of a service receiver, and the second device acts as a remote terminal device of a service transmitter.

16. A terminal device, comprising:
a processor and a memory storing one or more computer programs, which when executed by the processor, causes the terminal device to:
receive a first configuration parameter related to an end-to-end relay service from a first device in the end-to-end relay service, wherein a first remote terminal device, a relay terminal device, and a second remote terminal device participate in the end-to-end relay service, and the first configuration parameter comprises at least one of:
an end-to-end configuration parameter, wherein the end-to-end configuration parameter comprises a configuration parameter for service transmission between the first remote terminal device and the second remote terminal device;
a first per-hop configuration parameter, wherein the first per-hop configuration parameter comprises a configuration parameter for service transmission between the first remote terminal device and the relay terminal device; or
a second per-hop configuration parameter, wherein the second per-hop configuration parameter comprises a configuration parameter for service transmission between the second remote terminal device and the relay terminal device.

17. The terminal device according to claim 16, wherein:
in a case that the first configuration parameter comprises the end-to-end configuration parameter, the first device acts as the first remote terminal device or the second remote terminal device, and the terminal device acts as the relay terminal device;
in a case that the first configuration parameter comprises the first per-hop configuration parameter, the terminal device acts as the relay terminal device, and the terminal device acts as the first remote terminal device; and
in a case that the first configuration parameter comprises the second per-hop configuration parameter, the terminal device acts as the relay terminal device, and the terminal device acts as the second remote terminal device.

18. The terminal device according to claim 16, wherein the first configuration parameter comprise at least one of an end-to-end quality of service (QoS) parameter, an end-to-end Sidelink Relay Adaptation Protocol (SRAP) configuration parameter, an end-to-end Packet Data convergence Protocol (PDCP) configuration parameter, an end-to-end Service Data Adaptation Protocol (SDAP) configuration parameter, a per-hop QoS parameter, or a per-hop radio link control (RLC) configuration parameter.

19. The terminal device according to claim 16, wherein the one or more computer programs, which when executed by the processor, further causes the terminal device to:
transmit a reconfiguration request message to the first device in response to rejection of the first configuration parameter, wherein the reconfiguration request message requests to reconfigure the first configuration parameter, and comprises second configuration parameter related to the end-to-end relay service, wherein the second configuration parameter is determined by the terminal device, or, the second configuration parameter is determined by a network device of the terminal device; and
receive a reconfigured first configuration parameter from the first device.

20. The terminal device according to claim 16, wherein the terminal device is a relay terminal device in the end-to-end relay service and is beyond a network coverage; and
wherein the one or more computer programs, which when executed by the processor, further causes the terminal device to:
select configuration information corresponding to a bearer based on a selection priority of each set of configuration information in a case that a same bearer corresponds to a plurality of sets of quality of service (QoS) parameters and each set of the plurality of sets of QoS parameters corresponds to a set of configuration information, wherein the configuration information comprises at least one of Sidelink Relay Adaptation protocol (SRAP) configuration parameters or radio link control (RLC) configuration parameters, and the selection priority is correlated with at least one of a proximity services communication 5 (PC5) 5G QoS identifier (PQI) in each of the plurality of sets of QoS parameters, a packet delay budget (PDB) in each of the plurality of sets of QoS parameters, or explicit priority information, wherein different PDB levels correspond to different pieces of configuration information, and each PDB level corresponds to a PDB value range.
